(19) United States
(12) Patent Application Publication
(10) Pub. No.: US 2022/0351309 A1
(43) Pub. Date: Nov. 3, 2022

(54) SYSTEM AND METHOD OF SERVING FOOD AND DRINKS TO CLIENTS

(71) Applicant: FREE COMPANY, Moscow (RU)

(72) Inventors: LEV LEVITAS, Toronto (CA); YURY LEVITAS, Staten Island, NY (US)

(73) Assignee: FREE COMPANY, Moscow (RU)

(21) Appl. No.: 17/306,488

(22) Filed: May 3, 2021

(51) Int. Cl. G06Q 50/12; G06Q 30/02; G06K 19/06; G06Q 30/06; G06F 21/44

(52) U.S. Cl. CPC G06Q 50/12; G06Q 30/0221; G06Q 30/0225; G06K 19/06112; G06K 19/06037; G06Q 30/0631; G06F 21/44; G06Q 20/3274

(57) ABSTRACT

In a system and a method of the invention at least one food and/or drinks serving facility is provided, an electronic device of each of a plurality clients has an application with a QR code allowing a client to receive from it food and drink free of charge without any obligation to purchase it, the client can select a food and/or a drink which he/she wants to receive from the serving facility and shows to a cashier the OR code of the application on his/her electronic device, so that the cashier can read it and ascertain that the application is appropriate and valid, and then the client can receive from the serving facility the selected food and/or drink for free without any payment a certain number of times.

### BACKGROUND OF THE INVENTION

The present invention relates to systems and methods of serving foods and drinks to clients.

It is well known that in food stores, restaurants, cafeterias etc. clients order foods and drinks which of interest for them, then consume them or take them to bring home and pay a cashier, or pay to a cashier first and consume them or bring them home.

It is believed to be desirable to develop an approach which can attract the clients preferentially to a selected food and drink facility among a plurality of such facilities.

### SUMMARY OF THE INVENTION

Accordingly, it is an object of the present invention to provide a system and a method of serving foods and drinks which can attract clients to a specific food and drinks facility.

In keeping with these objects and with others which will become apparent hereinafter one feature of the present invention resides, briefly stated in a method of serving food and drinks to clients, comprising the steps providing at least one food and/or drinks serving facility, giving for an electronic device of each of a plurality clients an application with a QR code allowing a client to receive from the food and/or drinks serving facility a food and/or a drink free of charge without any obligation to purchase said food and/or said drink, selecting by the client a food and/or a drink from the food and/or drinks which he/she wants to receiving from the serving facility, showing by the client to a cashier of the food and/or drinks serving facility the QR code of the application on his/her electronic device, reading by the cashier the application on the client's electronic device and ascertaining that the application is appropriate and valid, and receiving by the client from the food and/or drinks serving facility the selected food and/or drink for free without any payment.

With the method specified hereinabove the clients will definitely prefer to go for a food or a drink to such a facility, in which for a certain number of times they can obtain foods and drinks without any payment.

According to another feature of the present invention the receiving by the client from the food and/or drinks serving facility the selected food and/or drink for free without any payment is operational only a certain number of times, after which a receiving by the client from the food and/or drinks serving facility the selected food and/or drink can be executed only with a payment.

According to a further feature of the present invention a company can be provided having information about the foods and/or drinks in the food and/or drinks serving facility, and the client can consult with the company which can recommend a client a respective one food and/or drug in the food and/or drug facility for the food/and or drink the client is willing to receive.

According to a further feature of the present invention with initiating the consulting by the client with the company the company can recommend a client a respective one food and/or drug in the food and/or drug facility for the food/and or drink the client is willing to receive by clicking in the application to a picture of the company.

According to a further feature of the present invention the company with which the client consults can be a company which executes the method of serving food and drinks according to the present invention.

Further features of the present invention reside in a novel system of serving foods and drinks to clients, which operates according to the above specified inventive features of the novel method of serving food and drinks to clients.

What is desired to be protected by a Letters Patent is set forth in particular in the appended claims.

The invention itself however will be best understood from the following description of the preferred embodiments, which is accompanied by the following drawings.

### BRIEF DESCRIPTION OF THE DRAWINGS

FIG. 1 is a view schematically showing a trade enterprise of the inventive system and method of serving food and drinks to clients, in which a client can obtain food and drinks according to the present invention;

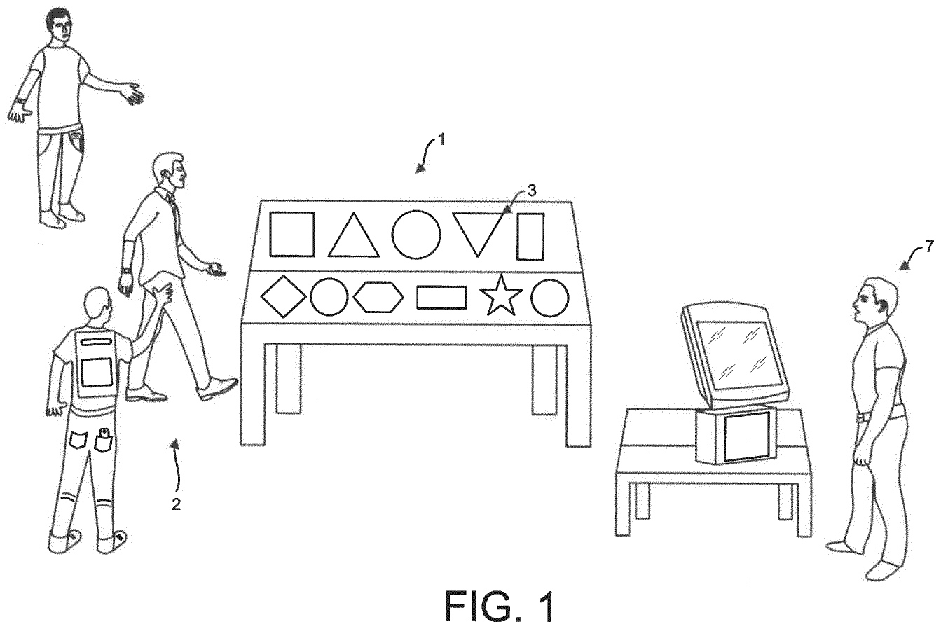

FIG. 2 is a view schematically showing a company which operates the inventive system and method of serving food and drinks according to the present invention;

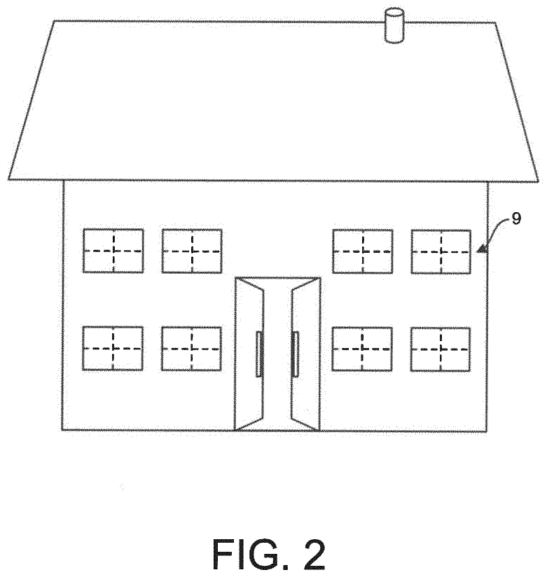

FIG. 3 is a view showing a screen of a cellphone, which a client can use for obtaining food and drinks in accordance with the inventive system and method of serving food and drinks; and

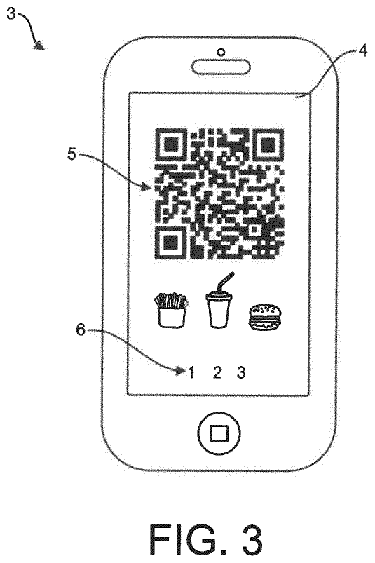

FIG. 4 is a view schematically illustrating the inventive system and method of serving food and drinks to clients with interconnection of its components.

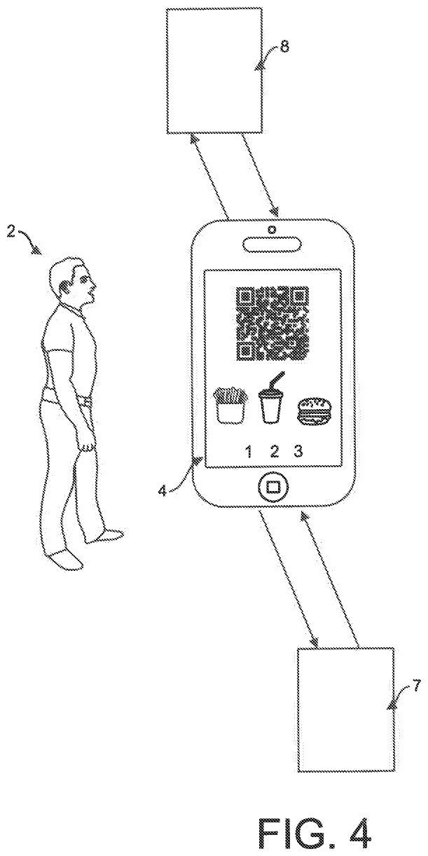

### DESCRIPTION OF THE PREFERRED EMBODIMENTS

A new system of serving food and drinks to clients which implements a new method of serving food and drinks for clients includes at least one food and/or drinks serving facility which is identified with reference numeral 1. The food and/or drink serving facility 1 has an assortment of foods and drinks 3. It can be a restaurant, a bar, and any other food and drinks serving enterprise which has food and drink in its possession, ready to be served to clients. A cashier 7 is operating in the food and/or drinks serving facility 1.

The system further includes the clients 2 which are a part of the whole system and possesses an electronic device such as for example a cell phone 4. The cellphone 4 has a screen which can exhibits on it a QR code that is specific to the client 2.

The whole system is operated by a company 8, which also can be contacted by the clients to obtain information about the location of the food and/or drinks facility including its locations and assortments of the food and drinks.

A client 2 enters the food and drinks serving facility 1 and selects a food and/or a drink 3 which he or she is willing to obtain. At a certain location of the food and drinks serving facility 1 there is the cashier 7 who conventionally is approached by the clients who selected the food and/or drinks, calculates the total price of the selected food and/or drinks, and obtains a corresponding payment for them from the clients.

The system according to the present invention however operates with the method according to the present invention in a different manner. The client 2 carries with him/her an electronic device, for example the cell phone 3 with the screen 4 capable of showing the QR code 5 and a symbol 6 showing how many foods and/or drinks he/she already obtained and when he/she obtained this food and/or drink from this particular serving facility 1.

The system can be designed for example so that the client 2 can obtain from this particular serving facility 1 completely free only one food and/or drink a day. The client 2 after selecting a food and/or a drink approaches the cashier 7 who familiarizes himself with the screen 4 of his/her cell phone 3.

If it shows that that the client 2 today did not obtain a food or a drink from this facility 1, the cashier 7 allows the client 2 to take the food and/or drink selected by the client 2 for free. If however the cashier 7 see on the screen 4 of the client's cellphone that the client 2 today already received a free food or drink, the cashier 7 cannot give the client 2 another food or drink for free and instead collects the payment for this food or drink selected by the client.

The client 2 can also contact the company 8 which implements the system according to the present invention and can be located at a different remote location from the facility 1. The client 2 can communicate with the company 8 remotely, for example by his cell phone 3, and the company 8 gives the client information about food and drinks which are in general available in several food and drink facilities. The company also can give the client 2 information in which facility the client 2 can find food and drinks of interest to him/her.

The new system of obtaining foods and/or drinks can provide the clients 2 with foods and drinks desired by them for free in accordance with the established frequency, for example once a day. Of course, a different frequency can be utilized as well in the new system of the present invention.

The present invention is not limited to the details shown since various modifications and structural changes are possible without departing from the spirit of the invention.

What is desired to be protected by Letters Patent is set in particular in the appended claims.

1-12. (canceled)

13. A system of serving food and drinks to clients, comprising:
at least one foods and drinks serving facility;
an electronic device owned by each of a plurality of clients and having an application with a QR code and a symbol showing how many foods and drinks a client already obtained once a day and allowing the client to receive from the foods and drinks serving facility once a day or with a different frequency a food and a drink free of charge, such that when the client selects a food or a drink from the foods and drinks serving facility and shows to a cashier of the foods and drinks serving facility the QR code and the symbol on the client's electronic device, the cashier can read the QR code and the symbol and ascertain that the application is appropriate and valid and then the client receives from the foods and drinks serving facility the selected food and drink for free without any payment once a day or with a different frequency; and
a company giving information to the client about a location of the foods and drinks serving facility and about the foods and drinks in the serving facility which the client is willing to receive, and the company also executing the serving of foods and drinks in the foods and drinks serving facility to the clients once a day or with a different frequency.

14. A method of serving food and drinks to clients, comprising the steps of:
providing at least one foods and drinks serving facility;
giving to each of a plurality clients an electronic device having an application with a QR code and a symbol showing how many foods and drinks a client already obtained once a day and allowing a client to receive from the foods and drinks serving facility once a day or with a different frequency a food and a drink free of charge, such that when the client selects a food or a drink from the food and drinks serving facility and shows to a cashier of the food and drinks serving facility the QR code and the symbol on the client's electronic device, the cashier can read the QR code and the symbol and ascertain that the application is appropriate and valid and then the client receives from the foods and drinks serving facility the selected food and drink for free without any payment once a day or with a different frequency; and
providing a company giving information to a client about a location of the foods and drinks serving facility and about the foods and drinks in the foods and drinks serving facility the client is willing to receive, and the company also executing the serving of foods and drinks in the foods and drinks serving facility to the clients once a day or with a different frequency.
